(19) United States
(12) Patent Application Publication
(10) Pub. No.: US 2021/0402228 A1
(43) Pub. Date: Dec. 30, 2021

(54) Strap-Free Disposable Face Mask

(71) Applicant: Susan Harron, Racine, WI (US)

(72) Inventor: Susan Harron, Racine, WI (US)

(21) Appl. No.: 17/326,656

(22) Filed: May 21, 2021

Related U.S. Application Data
(60) Provisional application No. 63/029,019, filed on May 22, 2020.

(51) Int. Cl. A62B 18/08; A41D 13/11

(52) U.S. Cl. CPC A62B 18/084; A41D 13/1176

(57) ABSTRACT

A single-use face mask for protectively covering a user's respiratory breathing openings includes a face-covering material dimensioned to cover the user's breathing openings and extending therefrom to an annular marginal edge portion for positioning over the user's face at positions beyond the breathing openings, an annular strip of medical-grade adhesive on the inner surface positioned at a marginal edge portion near and along the annular edge, the medical-grade adhesive selected to hold the face-covering material in substantially fixed position on the user's face, the adhesive-bearing marginal edge portion being recessed sufficiently from the annular edge of the material to facilitate gripping of the material along the annular edge for conveniently peeling the single-use mask from the user's face.

### RELATED APPLICATION

The application claims priority based on Provisional Patent Application Ser. No. 63/029,019 filed May 22, 2020, the entire contents of which are incorporated herein by reference.

### FIELD OF THE INVENTION

The invention relates to face masks worn in public to stop the spread of germs and viruses such as Covid-19.

### BACKGROUND OF THE INVENTION

Conventional face masks, having straps or lines of various sorts, often elastic, for extending around each of the ears of a user or around the back of the user's head, are often cumbersome and uncomfortable, particularly in certain situations. Examples of such situations include the wearing of masks by customers during hair salon and barbershop appointments. Other difficult situations involve the wearing of masks by children or by persons with special needs. Various issues arise, including improper mounting by the user and frequent dislodgement, and the resulting need for correction or readjustment. Furthermore, constant touching and rearranging of masks by the wearers or persons assisting wearers may render the masks useless or at least less useful as an effective barrier for germs.

There are particular problems that tend to occur with conventional face masks in hair salon usage, as will now be described. In such usage, conventional masks with straps experience problems related to mask straps coming into contact with water; for example, particularly during shampooing or color treatment, the straps of conventional masks can become saturated with water or other liquids, such that the straps act like a wick for the liquid such that the wearer has to sit through a lengthy appointment with uncomfortable wet straps—or else discard the mask entirely and replace it with another strap. Moreover, traditional strapped masks may also get snagged or tangled during hair brushing, combing and styling.

Still another problem with respect to protective conventional face masks is sometimes experienced with respect to properly locating the upper edge of a mask in the correct over-the-nose position, engaging the user's nose properly to assure proper closure of the mask. In fact, these problems are so common and extreme that a significant percentage of mask wearers are observed with the upper edge of the mask on their upper lips, actually below their nostrils. The problems with conventional face masks, particularly those related to improper positioning, are related not just to the structure of the masks but to the ways in which face masks are secured to users.

Other related problems associated with conventional masks are experienced by those wearing eyeglasses, including in particular in those situations in which the user's glasses are put on and taken off repeatedly, such as for label reading in retail stores or the like. The interactions of eyeglasses with a mask, both near the user's ears and at the location where the over-the-nose portion of the mask interacts with the over-the-nose portions of the eyeglasses (e.g., the bridge and nose pads), pose common problems—problems going even to the effectiveness of masks for their intended purposes.

These problems pertain to masks of the sort used by millions of people going about their daily business or engaged in social interactions. But mask-wearing problems also exist is specialized applications, such as surgical and other medical uses, protective uses in food-handling applications, and a wide variety of other applications. In any application in which proper leak-avoiding mounting is essential, there is a continuing need for face-mask improvement.

In summary, there are numerous problems related to conventional protective face masks and how they are mounted for use to a user's face. It is to a solution for these problems that this invention is directed.

### SUMMARY OF THE INVENTION

The present invention is a respiratory protective mask which overcomes the above-mentioned problems while protectively covering a user's respiratory breathing openings to prevent ingress and egress of harmful airborne bacterial and viral materials and airborne solids while permitting respiration.

The inventive mask includes a face-covering material dimensioned to cover the user's breathing openings and extending therefrom to an annular edge for positioning over the user's face at positions beyond the breathing openings. The material, which may or may not itself be layered for various purposes related to removal of materials passing therethrough, is selected to serve the desired protective purposes. An annular strip of medical-grade adhesive is on the inner surface of the material at a marginal marginal edge portion which is near and along on annular edge. The medical-grade adhesive of such annular strip is selected to adhere the face-covering material in fixed position covering the user's breathing openings, with the annular strip fully surrounding the breathing openings. This 360-degree annular-strip adhesive engagement serves to prevent significant passage of air past the annular marginal edge portion of the mask.

In preferred embodiments, the medical-grade adhesive strip on the annular marginal edge portion has a width of about 0.2-0.5 inch. In highly preferred embodiments, it has been found that the adhesive strip having a width of no more than about 0.375 inch provides excellent mask adhesion in accordance with this invention.

In order to facilitate removal of the protective mask of this invention, the annular edge of the material extends somewhat beyond the adhesive-bearing marginal edge portion. In other words, the adhesive-bearing marginal edge portion is recessed sufficiently from the annular edge of the material to facilitate gripping of the material along its annular edge for easy peeling of the mask from the face of the user. Most preferably, the annular edge extends at least about one-sixteenth of an inch beyond the adhesive-bearing marginal edge portion, either all the way around the annular edge or at least at some locations around the annular edge.

The protective mask preferably further includes, prior to use, a removable adhesive-protection layer which can be peeled off prior to applying the mask to a user. It is highly preferred that the adhesive-protection layer substantially covers the entirety of the inner surface of the face-covering material.

In the present invention, the strip of medical-grade adhesive can be the sole means of attachment of the mask to the user's face. The mask is preferably strapless, i.e., free of straps and lines for attachment purposes.

The protective mask of this invention preferably has face-covering material which is flexible so it can conform to the contours of the face of a user. The face-covering material is preferably capable of being in a substantially-rectangular planar shape prior to use, and so susceptible to packaging in the manner typically used for large bandages of various sizes. In some cases it is desirable for the face-covering material to have pleats or gatherings therein to facilitate conforming to the contours of the user's face.

The mask of this invention overcomes numerous problems with conventional respiratory-covering face masks, including those problems referred to above. Among other things, the inventive mask minimizes improper mounting to the user, the problem of frequent dislodgement, and a need for correction or readjustment. Constant touching and rearranging of masks by the wearer or someone assisting the wearer is avoided, increasing mask effectiveness for its intended purposes as a barrier for germs.

In uses for persons receiving hair salon services, problems of mask straps contacting water during shampooing or color treatment are sidestepped entirely, as are problems of hair interference, tangling and snagging of straps or lines during combing or other hair manipulation.

And problems related to maintaining proper location of the mask on the user's face, and particularly with respect to keeping the proper location of the upper edge of a mask in the correct over-the-nose position and avoiding any interference with the nose-bridge or other portions of eyeglasses, are also overcome. The masks of this invention are reliably maintained in their intended and effective positions on users' faces, and they also assure an appropriate seal so that full effectiveness of the mask material is not lost. This is true for usage by children and by adults, including for persons with special needs.

Applying, using and then easily removing and promptly disposing of protective face masks in accordance with this invention are another distinct advantage. The nature of masks of this invention is such that disposal after use, rather than any repeated use and re-use, with all the risks such re-use can entail, is implicit.

### BRIEF DESCRIPTION OF THE DRAWING FIGURES

FIG. 1 is a perspective view of a woman wearing a mask which is a preferred embodiment of this invention.

FIG. 2 is a front view of the woman wearing such mask.

FIG. 3 is a front view of the mask before mounting on a user's face.

FIG. 4 is a back view of the mask of FIG. 3.

FIGS. 5 and 6, respectively, are front and back views of a similar child-size mask before mounting on a child's face.

FIG. 7 is a back view of the removable adhesive-protection layer.

### DESCRIPTIONS OF PREFERRED EMBODIMENTS

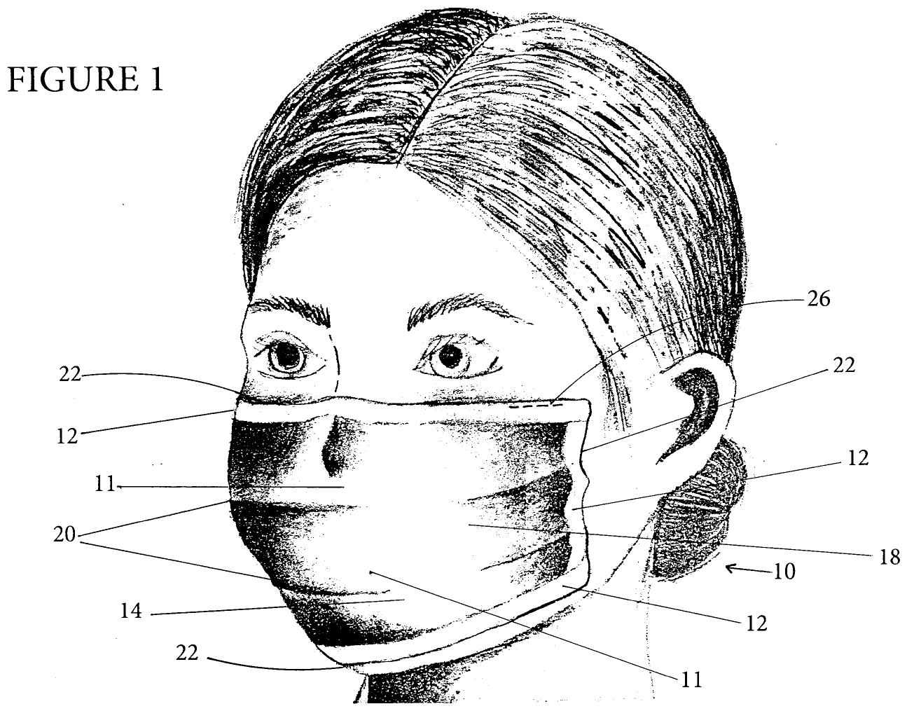

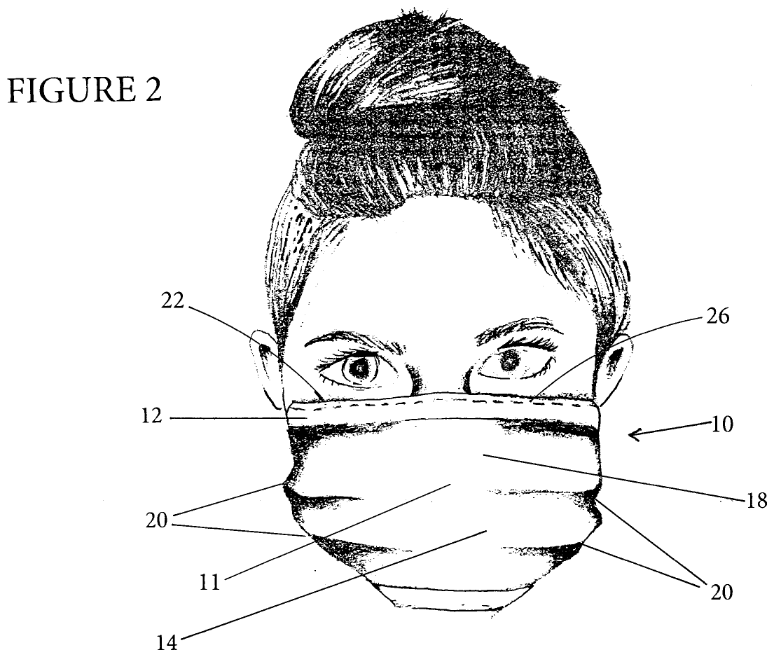

As can be seen from the drawing figures, the masks 10, which are preferred embodiments of this invention, are strapless, i.e., entirely free of any straps, lines or cords of any sort for extending over and around a user's ears or around a user's head. It can also be seen from FIGS. 1 and 2 that inventive mask 10 entirely covers the wearer's nose and mouth, and that the large air-transmitting middle area 11 of mask 10 is entirely surrounded by an annular part of the mask which serves to removably engage the mask to a user's face.

More specifically, mask 10 is formed of a material 14 which has an inner surface 16, and outer surface 18, and terminates in an annular edge 22. As seen best in FIGS. 4 and 6, mask 10 also includes a marginal edge portion 12 near and along annular edge 22, such marginal edge portion covered on inside surface 16 of material 14 by an annular strip 24 of medical-grade adhesive permanently adhered to inner surface 16. Adhesive-bearing marginal edge portion 12 of mask 10 entirely surrounds air-transmitting middle area 11, and the annular adhesive strip 24 serves to fully engage mask 10 with the user's face. This provides fixed-in-place mounting and entirely ensures the intended protection.

Face-covering material 14 of strapless mask 10 of this invention may be of one or more layers of material 14. A three-layer construction (layering not shown in the drawings) is preferred, including an inner soft non-woven fabric layer, a middle blown fabric layer, and an outer soft non-woven fabric layer. Such layers forming material 14 are chosen for appropriate filtering (by ingress or egress) of undesirable particles of all sorts, as appropriate for the desired protection.

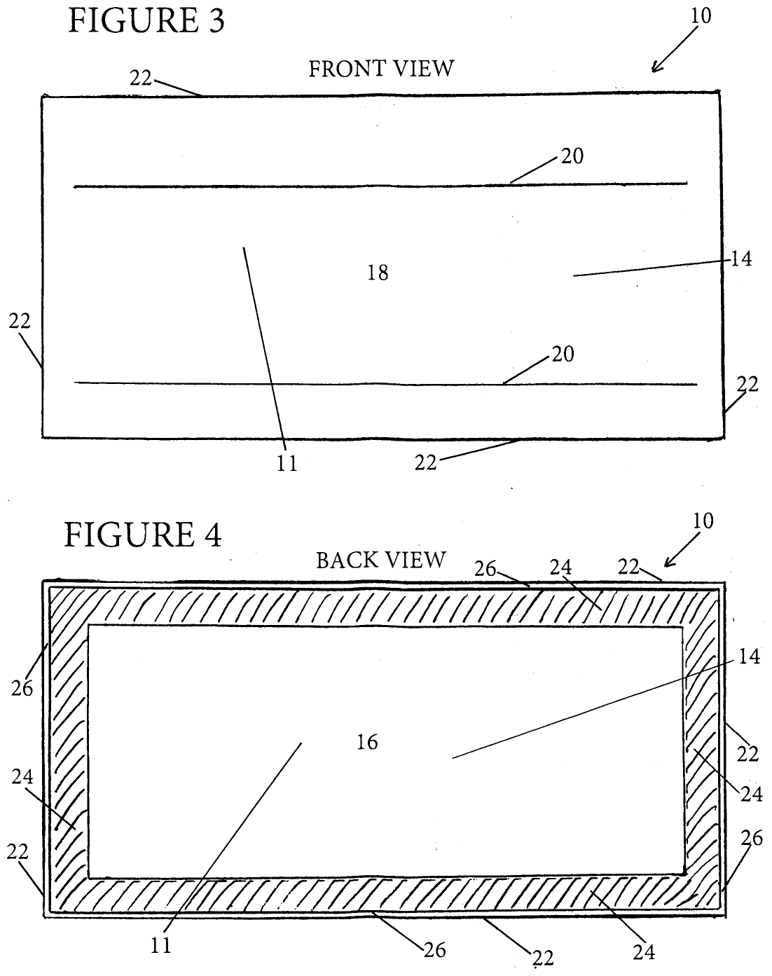

The masks illustrated in FIGS. 1-4, which are of an adult size, are preferably about 7 inches wide and 3.5 inches high, when measured in a flat pre-mounted condition.

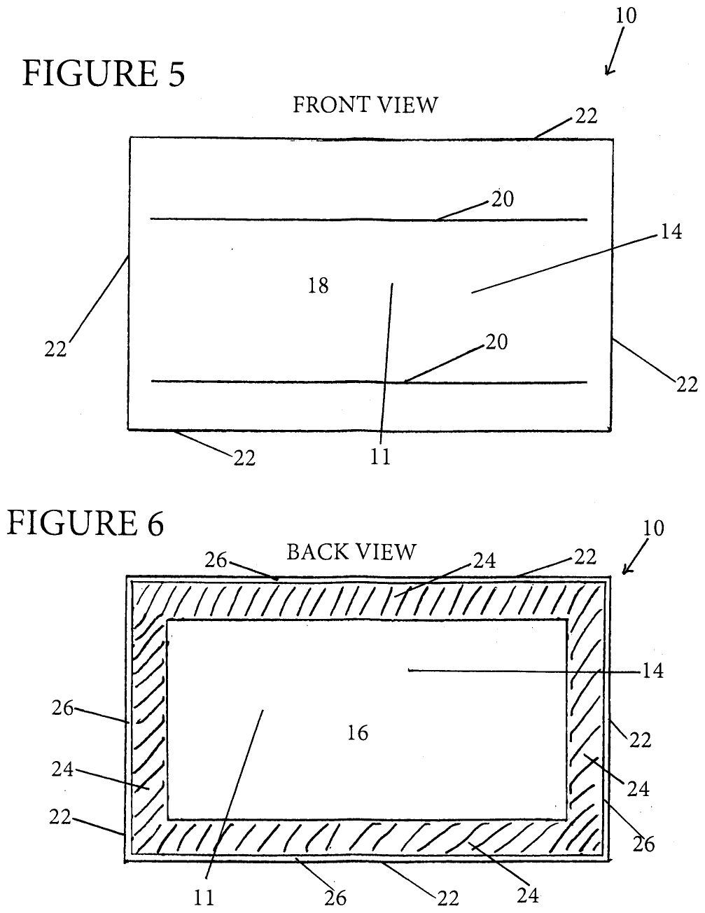

The masks illustrated in FIGS. 5 and 6, which are of a child size, are preferably about 5 inches wide and 3 inches high. Face-covering material 14 of masks 10 has sewn-in or otherwise-created pleats 20 to allow expansion and contraction in order to accommodate the shapes of the users' faces, and also to some extent to accommodate users' breathing and speaking.

The width of annular strip 24 of medical-grade adhesive strip is preferably about 0.375 inch, which has been found to be sufficient with most medical-grade adhesives to provide a highly-reliable seal between the user's face and mask 10. Annular adhesive strip 24 extends (1) over and on the nose of the user, (2) laterally therefrom in either direction over the cheeks of the user, (3) downwardly therefrom on the user's face in positions spaced forwardly from the location of the user's ears, and (4) from there around (or even under) the user's chin to complete the 360-degree annular sealing of mask 10 to the user's face. While a strip width of 0.375 inch is most preferred, a strip width within the range of about 0.2-0.5 inch functions well. Appropriate strip widths and medical-grade adhesives can be determined based on knowledge of this invention.

As seen best in FIGS. 4, 6 and 7, annular edge 22 of mask 10 is somewhat beyond adhesive-bearing marginal edge portion 12 of mask 10; that is, adhesive-bearing marginal edge portion 12 is recessed from annular edge 22, creating a grippable area 26 of material 14, and this positioning of annular adhesive strip 24 is such that manual gripping of mask 10 at grippable area 26 near annular edge 22 facilitates gripping of material 14 to allow easy peeling of mask 10 from the user's face. This recessed configuration is preferably all around mask 10, but may only be along certain portions of mask 10—portions deemed likely to be gripped by a user during the removal process. The recessing is preferably at least about one-sixteenth of an inch. While the recessing feature and grippable area 26 is best illustrated in FIGS. 4, 6 and 7, the dotted line in FIG. 2 and the dotted-line portion in FIG. 1 also indicate this convenient feature.

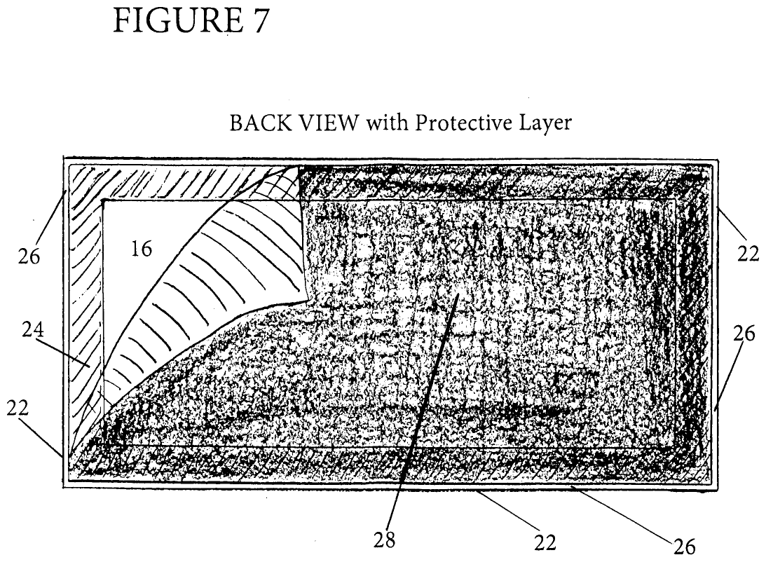

FIG. 7 illustrates a removable adhesive-protection layer 28 which, prior to use, covers and protects adhesive strip 24 so that the adhesive is fully effective when the adhesive-protection layer 28 is peeled off and the mask 10 is mounted to the user's face. The adhesive-protection layer 28 can be in strips or in an annular ring, but most preferably is a full sheet covering entire inner surface 16 the face-covering material 14. This facilitates usage of the disposable face mask 10 of this invention.

A wide variety of materials 14 are acceptable for the elements and parts of inventive face mask 10. As already stated, a wide variety of face-covering materials may be used, and appropriate choices will be apparent to those skilled in the art who are also made aware of the characteristics of the present invention. Likewise, a wide-variety of appropriate medical-grade adhesives can be used, and application of the medical-grade adhesive can be by direct adhesive application to material 14 or by other attaching such as stitching a strip of material bearing such adhesive to the appropriate location on inner surface 16 of face-covering material 14. Suitable choices of the adhesive-protection layer 28 for pre-usage covering of the adhesive strip 24 will also be apparent to those skilled in the art who are also made aware of the characteristics of the present invention. One choice for this protection layer is waxed paper of an appropriate thickness.

The masks of this invention are intended for one-time use, and stated above the characteristics of mask 10 are such that one-time use nearly universally implied. After manufacture and before use each mask is preferably individually packaged, preferably in a manner typical for single-use bandages. However, a variety of packaging choices are available.

1. A mask for protectively covering a user's respiratory breathing openings to prevent ingress and egress of harmful airborne bacterial, viral materials and airborne solids while permitting respiration, the mask comprising:
a face-covering material dimensioned to cover the user's breathing openings and extending therefrom to an annular marginal edge portion for positioning over the user's face at positions beyond the breathing openings, the material selected to serve the protective purposes and having an inner surface and extending to an annular edge; and
an annular strip of medical-grade adhesive on the inner surface positioned at a marginal edge portion near and along the annular edge, the medical-grade adhesive selected to hold the face-covering material in substantially fixed position on the user's face covering the user's breathing openings with the annular strip fully surrounding the breathing openings,
thereby preventing significant passage of air past the marginal edge portion of the mask.

2. The protective mask of claim 1 wherein the medical-grade adhesive strip on the annular marginal edge portion has a width of about 0.2-0.5 inch.

3. The protective mask of claim 2 wherein the adhesive strip has a width of no more than about 0.375 inch.

4. The protective mask of claim 1 wherein the annular edge of the material extends somewhat beyond the adhesive-bearing marginal edge portion, thereby facilitating manual gripping of the mask for removal by peeling off the mask from the user's face.

5. The protective mask of claim 4 wherein the annular edge extends at least about one-sixteenth of an inch beyond the adhesive-bearing marginal edge portion at least at some locations around the annular edge

6. The protective mask of claim 1 further including a removable adhesive-protection layer which can be peeled off prior to application of the mask to a user's face.

7. The protective mask of claim 6 wherein the adhesive-protection layer substantially covers the entire inner surface of the face-covering material.

8. The protective mask of claim 7 wherein the adhesive-bearing marginal edge portion has a width of about 0.2-0.5 inch.

9. The protective mask of claim 8 wherein the adhesive-bearing marginal edge portion has a width of no more than about 0.375 inch.

10. The protective mask of claim 1 wherein the medical-grade adhesive is the sole means of attachment of the mask to the user's face.

11. The protective mask of claim 1 free of straps and lines for attachment purposes.

12. The protective mask of claim 1 wherein the face-covering material is flexible to conform to the contours of the user's face.

13. The protective mask of claim 12 wherein the face-covering material, when not mounted to the user's face, is capable of being in a substantially-rectangular planar shape.

14. The protective mask of claim 12 wherein the face-covering material has pleats or gatherings therein to facilitate conforming to the contours of the user's face.

15. A mask for protectively covering a user's respiratory breathing openings to prevent ingress and egress of harmful materials while permitting respiration, the mask comprising:
a face-covering material dimensioned to cover the user's breathing openings and extending therefrom to an annular marginal edge portion for positioning over the user's face at positions beyond the breathing openings, the material selected to serve the protective purposes and having an inner surface and extending to an annular edge;
an annular strip of medical-grade adhesive on the inner surface positioned at a marginal edge portion near and along the annular edge, the medical-grade adhesive selected to hold the face-covering material in substantially fixed position on the user's face covering the user's breathing openings with the annular strip fully surrounding the breathing openings, thereby preventing significant passage of air past the marginal edge portion of the mask; and
the adhesive-bearing marginal edge portion being recessed sufficiently from the annular edge of the material to facilitate gripping of the material along the annular edge for peeling of the mask from the user's face.
